(19) United States
(12) Patent Application Publication
(10) Pub. No.: US 2013/0344386 A1
(43) Pub. Date: Dec. 26, 2013

(54) POSITIVE ACTIVE MATERIAL FOR LITHIUM SECONDARY BATTERY, METHOD OF PREPARING THE SAME, POSITIVE ELECTRODE FOR LITHIUM SECONDARY BATTERY INCLUDING THE POSITIVE ACTIVE MATERIAL, AND LITHIUM SECONDARY BATTERY EMPLOYING THE POSITIVE ELECTRODE

(71) Applicant: SAMSUNG SDI CO., LTD., Yongin-si (KR)

(72) Inventors: Do-Yu KIM, Yongin-si (KR); Jin-Hyoung SEO, Yongin-si (KR); Mi-Ran SONG, Yongin-si (KR); Yong-Chul PARK, Yongin-si (KR); Gyeong-Jae HEO, Yongin-si (KR); Hyun-Deok LEE, Yongin-si (KR); Yong-Seon KIM, Yongin-si (KR); Min-Ju KIM, Yongin-si (KR); Na-Leum YOO, Yongin-si (KR)

(73) Assignee: SAMSUNG SDI CO., LTD., Yongin-si (KR)

(21) Appl. No.: 13/761,449

(22) Filed: Feb. 7, 2013

(30) Foreign Application Priority Data
Jun. 21, 2012 (KR) 10-2012-0066982

(51) Int. Cl. H01M 4/525; H01M 4/131

(52) U.S. Cl. CPC H01M 4/525; H01M 4/131
USPC 429/221; 429/223; 252/182.1

(57) ABSTRACT

A positive active material for a lithium secondary battery is a compound represented by Formula 1 and is in a form of primary particles having a particle diameter in a range of 80 to 400 nm. Formula 1: LiₐNiₓCo_{y}Mn_{z}M_{1-x-y-z}O₂, wherein metal M is selected from the group of B, Cr, V, Ti, Fe, Zr, Zn, Si, Y, Nb, Ga, Sn, Mo, and W, 1.0≦a≦1.2, 0.9≦x≦0.95, 0.1≦y≦0.5, 0.0≦z≦0.7, and 0.0<1−x−y−z≦0.3.

### CROSS-REFERENCE TO RELATED APPLICATION

This application claims the benefit under 35 U.S.C. §119 of Korean Patent Application No. 10-2012-0066982, filed on Jun. 21, 2012, in the Korean Intellectual Property Office, the disclosure of which is incorporated herein in its entirety by reference.

### BACKGROUND

1. Field

One or more embodiments relate to a positive material for a lithium secondary battery, a method of preparing the same, a positive electrode for a lithium secondary battery including the positive active material, and a lithium secondary battery employing the positive electrode.

2. Description of the Related Art

The use of lithium secondary batteries in mobile phones, camcorders, and laptops has increased. A factor that affects the capacity of a lithium secondary battery is the positive active material. Characteristics of usability for a long time at a high rate or maintenance of initial capacity after a charging and discharging cycle may be affected according to electrochemical characteristics of the positive active material.

A lithium cobalt oxide or lithium nickel composite oxide may be used as the positive active material in the lithium secondary battery.

### SUMMARY

Embodiments are directed to a positive active material for a lithium secondary battery, the positive active material being a compound represented by Formula 1 below and being in a form of primary particles having a particle diameter in a range of 80 to 400 nm:

LiₐNiₓCo_{y}Mn_{z}M_{1-x-y-z}O₂ Formula 1

wherein metal M is selected from the group of B, Cr, V, Ti, Fe, Zr, Zn, Si, Y, Nb, Ga, Sn, Mo, and W,
1.0≦a≦1.2,
0.9≦x≦0.95,
0.1≦y≦0.5,
0.0≦z≦0.7, and
0.0<1-x-y-z≦0.3.

M may be Ti.

The positive active material may be a compound represented by Formula 2 below:

LiₐNiₓCo_{y}Mn_{z}Ti_{1-x-y-z}O₂,wherein Formula 2
1.0≦a≦1.2,
0.9≦x≦0.95,
0.15≦y≦0.5,
0.0≦z≦0.7, and
0.0<1-x-y-z≦0.3.

In Formula 1, x may be in a range of 0.9 to 0.93, z may be in a range of 0.02 to 0.03, and 1−x−y−z may be in a range of 0.01 to 0.03.

The positive active material may be Li_{1.03}Ni_{0.90}Co_{0.05}Mn_{0.025}Ti_{0.025}O₂, Li_{1.03}Ni_{0.9125}CO_{0.05}Mn_{0.025}Ti_{0.0125}O₂, Li_{1.03}Ni_{0.914}Co_{0.051}Mn_{0.025}Ti_{0.01}O₂, or Li_{1.03}Ni_{0.905}CO_{0.05}Mn_{0.025}Ti_{0.02}O₂.

The positive active material is formed by a method that includes mixing a Ni—Mn—Co composite hydroxide, a lithium precursor, and a metal oxide of the metal M, wherein M has the same meaning as in Formula 1, the metal oxide having a particle diameter in a range of 10 to 100 nm, to form a mixture, and heat-treating the mixture at 750 to 800° C. to form the compound represented by Formula 1, the compound being in a form of primary particles having a particle diameter in a range of 80 to 400 nm.

The metal oxide may be titanium oxide. The metal oxide may be titanium oxide in a rutile phase.

The heat-treatment may be performed under atmospheric conditions or in an oxygen atmosphere.

An amount of the metal oxide may be in a range of 0.01 to 0.03 mol based on 1 mol of the lithium precursor.

The positive active material may be formed by a method that includes mixing a composite hydroxide represented by Formula 3 and a lithium precursor to form a mixture, and heat-treating the mixture at 750 to 800° C. to form the compound represented by Formula 1, the compound being in a form of primary particles having a particle diameter in a range of 80 to 400 nm,

NiₓCo_{y}Mn_{z}M_{1-x-y-z}(OH)₂ Formula 3
wherein M in Formula 3 has the same meaning as in Formula 1,
0.9≦x≦0.95,
0.1≦y≦0.5,
0.0≦z≦0.7, and
0.0<1-x-y-z≦0.3.

The composite hydroxide represented by Formula 3 may be prepared by mixing a Ni-precursor, a Mn-precursor, a Co-precursor, a metal (M) precursor, and a solvent, wherein M has the same meaning as in Formula 1 and Formula 3, to form a mixture; and adjusting the pH of the mixture to form a precipitate and drying the precipitate. The pH of the mixture may be in a range of 12 to 12.4.

The composite hydroxide represented by Formula 3 may be a Ni—Mn—Co—Ti composite hydroxide represented by Formula 4 below:

NiₓCo_{y}Mn_{z}Ti_{1-x-y-z}(OH)₂ Formula 4
wherein
0.9≦x≦0.95,
0.1≦y≦0.5,
0.0≦z≦0.7, and
0.0<1-x-y-z≦0.3.

Embodiments are also directed to a positive electrode for a lithium secondary battery, the positive electrode including a positive active material for a lithium secondary battery that is represented by Formula 1 below, the positive active material being in a form of primary particles having a particle diameter in a range of 80 to 400 nm:

LiₐNiₓCo_{y}Mn_{z}M_{1-x-y-z}O₂ Formula 1

wherein metal M is selected from the group consisting of B, Cr, V, Ti, Fe, Zr, Zn, Si, Y, Nb, Ga, Sn, Mo, and W,
1.0≦a≦1.2,
0.9≦x≦0.95,
0.1≦y≦0.5,
0.0≦z≦0.7, and
0.0<1-x-y-z≦0.3.

Embodiments are also directed to a lithium secondary battery, including a positive electrode, a negative electrode; and a separator interposed between the positive and negative electrodes, the positive electrode being the positive electrode for a lithium secondary battery.

### BRIEF DESCRIPTION OF THE DRAWINGS

Features will become apparent to those of skill in the art by describing in detail exemplary embodiments with reference to the attached drawings in which:

FIG. 1 illustrates a perspective view schematically showing cross-section of a lithium secondary battery according to an embodiment;

FIG. 2 is a graph illustrating thermal stability of positive active materials prepared in Example 1 and Comparative Examples 1 to 3;

FIGS. 3 to 7 illustrate scanning electron microscope (SEM) images of positive active materials prepared in Examples 1 and 3 and Comparative Examples 1, 4, and 5; and

FIG. 8 is a graph illustrating charge and discharge of coin half cells prepared in Preparation Examples 1 and 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

As used herein, the term “and/or” includes any and all combinations of one or more of the associated listed items. According to an embodiment, there is provided a positive active material for a lithium secondary battery that is represented by Formula 1 below and includes primary particles having a particle diameter in a range of 80 to 400 nm:

LiₐNiₓCO_{y}Mn_{z}M_{1-x-y-z}O₂ Formula 1

where metal M is selected from the group of B, Cr, V, Ti, Fe, Zr, Zn, Si, Y, Nb, Ga, Sn, Mo, and W,
1.0≦a≦1.2,
0.9≦x≦0.95,
0.15≦y≦0.5,
0.0≦z≦0.7, and
0.0<1-x-y-z≦0.3.

In an implementation, M may be Ti.

The positive active material may be a compound represented by Formula 2 below.

LiₐNiₓCo_{y}Mn_{z}Ti_{1-x-y-z}O₂,where Formula 1
1.0≦a≦1.2,
0.9≦x≦0.95,
0.1≦y≦0.5,
0.0≦z≦0.7, and
0.0<1-x-y-z≦0.3.

In Formulas 1 and 2, x may be in a range of 0.9 to 0.93, z may be in a range of 0.02 to 0.03, and 1−x−y−z may be in a range of 0.01 to 0.03. Herein, “1−x−y−z” has the same meaning as “1−(x+y+z)”

According to the current embodiment, the positive active material is a Ni-rich compound, wherein a particle diameter of primary particles is in a range of 80 to 400 nm, for example, 100 to 400 nm. If the particle diameter of the primary particles of the positive active material is within the range described above, the positive active material may have a high rate capability and a high charge and discharge efficiency.

The positive active material may be used to prepare a lithium secondary battery having excellent capacity, and improved efficiency, as well as improved safety, by the doping of a metal, e.g., titanium.

The positive active material may be, for example, Li_{1.03}Ni_{0.90}CO_{0.05}Mn_{0.025}Ti_{0.025}O₂, Li_{1.03}Ni_{0.9125}CO_{0.05}Mn_{0.025}Ti_{0.0125}O₂, Li_{1.03}Ni_{0.914}Co_{0.051}Mn_{0.025}Ti_{0.01}O₂, or Li_{1.03}Ni_{0.905}C_{0.05}Mn_{0.025}Ti_{0.02}O₂.

Hereinafter, a method of preparing the positive active material for a lithium secondary battery will be described. An electrode active material for a lithium secondary battery that is represented by Formula 1 below and that is in a form of primary particles having a particle diameter in a range of 80 to 400 nm may be prepared by mixing a Ni—Mn—Co composite hydroxide, a lithium precursor, and a metal oxide of a metal M, wherein M as the same meaning as in Formula 1, the metal oxide having a particle diameter in a range of 10 to 100 nm, to form a mixture, and heat-treating the mixture at 750 to 800° C. to form the compound represented by Formula 1, the compound being in a form of primary particles having a particle diameter in a range of 80 to 400 nm.

LiₐNiₓCO_{y}Mn_{z}M_{1-x-y-z}O₂ Formula 1

wherein, metal M in Formula 1 is selected from the group of B, Cr, V, Ti, Fe, Zr, Zn, Si, Y, Nb, Ga, Sn, Mo, and W,
1.0≦a≦1.2,
0.9≦x≦0.95,
0.0≦z≦0.7, and
0.0<1-x-y-z≦0.3.

The heat-treatment may be performed at 750 to 800° C. By the heat-treatment, the positive active material represented by Formula 1 may be obtained. The heat-treatment may be conducted in an oxygen atmosphere or under atmospheric conditions.

The lithium precursor may be lithium hydroxide, lithium fluoride, lithium carbonate, or any suitable mixture thereof. In addition, the amount of the lithium precursor may be stoichiometrically controlled to obtain the positive active material represented by Formula 1.

The metal oxide may be titanium oxide. The titanium oxide may have a particle diameter in a range of 10 to 100 nm and may be in a rutile phase.

A melting point of titanium oxide varies according to its crystalline structure. According to an embodiment, the titanium oxide with the rutile phase has a melting point ranging from 350 to 400° C. By using such titanium oxide, primary particles may have a particle diameter within the range described above, and the positive active material represented by Formula 1 may be easily prepared.

The amount of the metal oxide may be in a range of 0.01 to 0.03 mol based on 1 mol of the lithium precursor. If the amount of the metal oxide is within the range described above, a positive active material of Formula 1 including primary particles having a particle diameter ranging from 80 to 400 nm may be obtained.

The Ni—Mn—Co composite hydroxide may be prepared according to the following process.

First, a Ni-precursor, a Mn-precursor, a Co-precursor, and a solvent are mixed.

The mixture is subjected to precipitation in a nitrogen atmosphere, at 40 to 50° C., by controlling the pH of the mixture using a pH regulator. Precipitates are washed, water-separated, and dried to obtain the desired Ni—Mn—Co composite hydroxide.

The Ni-precursor may be nickel sulfate, nickel nitrate, nickel chloride, or the like, and the Co-precursor may be cobalt sulfate, cobalt nitrate, cobalt chloride, or the like.

The Mn-precursor may be manganese sulfate, manganese nitrate, manganese chloride, or the like.

The amount of the Ni-precursor, Mn-precursor, and Co-precursor may be stoichiometrically controlled with regard to the positive active material of Formula 1.

The pH regulator may be a sodium hydroxide solution, ammonia water, or the like.

The pH of the mixture may be controlled within a range of 12.0 to 12.4, for example, 12.2 to 12.3, by controlling the content of the pH regulator.

Precipitates may be collected from the resultant, washed using pure water, and dried to obtain the Ni—Mn—Co composite hydroxide.

The solvent may be ethanol, pure water, or the like.

The amount of the solvent may be in a range of 100 to 2000 parts by weight, for example, 110 to 120 parts by weight, based on 100 parts by weight of the Ni-precursor. If the amount of the solvent is within the range described above, a mixture in which elements are uniformly mixed may be obtained.

In another implementation, the electrode active material for a lithium secondary battery that is represented by Formula 1 and that is in a form of primary particles having a particle diameter in a range of 80 to 400 nm may be prepared by mixing a composite hydroxide represented by Formula 3 and a lithium precursor to form a mixture, and heat-treating the mixture at 750 to 800° C. to form the compound represented by Formula 1, the compound being in a form of primary particles having a particle diameter in a range of 80 to 400 nm,

NiₓCo_{y}Mn_{z}M_{1-x-y-z}(OH)₂ Formula 3
wherein metal M in Formula 3 has the same meaning as in Formula 1,
1.0≦a≦1.2,
0.9≦x≦0.95,
0.1≦y≦0.5,
0.0≦z≦0.7, and
0.0<1-x-y-z≦0.3.

For example, the composite hydroxide represented by Formula 3 may be a Ni—Mn—Co—Ti composite hydroxide represented by Formula 4 below:

NiₓCo_{y}Mn_{z}Ti_{1-x-y-z}(OH)₂ Formula 4
wherein
1.0≦a≦1.2,
0.9≦x≦0.95,
0.1≦y≦0.5,
0.0≦z≦0.7, and
0.0<1-x-y-z≦0.3.

The composite hydroxide represented by Formula 3 may be formed under the same conditions as the Ni—Mn—Co composite hydroxide discussed above, except with the addition of an M-precursor to the Ni-precursor, a Mn-precursor, a Co-precursor, a solvent.

It is to be understood that the M-containing metal oxide and the M-containing composite hydroxide, where M has the same meaning as in Formula 1, may be used together in forming the compound of Formula 1.

Hereinafter, a method of preparing a lithium secondary battery using the positive active material for a lithium battery will be described in detail. The lithium secondary battery includes a positive electrode, a negative electrode, a lithium salt-containing non-aqueous electrolyte, and a separator.

The positive electrode and the negative electrode are respectively prepared by coating a composition for forming a positive active material layer and a composition for forming a negative active material layer on a current collector, and drying the resultant structure.

The composition for forming the positive active material layer is prepared by mixing a positive active material, a conductive agent, a binder, and a solvent, wherein a lithium composite oxide represented by Formula 2 may be used as the positive active material.

The binder is a component that assists binding of an active material to a conductive material and a current collector. Examples of the binder may include polyvinylidene fluoride, polyvinyl alcohol, carboxymethylcellulose (CMC), starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, and various copolymers. The content of the binder may be in a range of about 1 to about 50 parts by weight, for example, about 2 to about 5 parts by weight based on 100 parts by weight of the positive active material. When the content of the binder is within this range, the active material layer may have a strong binding ability to the current collector.

Any conductive material may be used without particular limitation so long as it has suitable conductivity without causing adverse chemical changes in the fabricated secondary battery. Examples of the conductive agent are graphite, such as natural graphite or artificial graphite; a carbonaceous material, such as carbon black, acetylene black, Ketjen black, channel black, furnace black, lamp black, and thermal black; a conductive fiber, such as carbon fiber and metallic fiber; a metallic powder, such as carbon fluoride powder, aluminum powder, and nickel powder; a conductive whisker, such as zinc oxide and potassium titanate; a conductive metal oxide, such as titanium oxide; and a polyphenylene derivative.

The amount of the conductive agent may be in a range of about 2 to about 5 parts by weight based on 100 parts by weight of the positive active material. If the amount of the conductive agent is within the range described above, the electrode may have excellent conductivity.

The solvent may be N-methylpyrrolidone, or the like, as an example.

The amount of the solvent may be in a range of about 1 to about 10 parts by weight based on 100 parts by weight of the positive active material. When the amount of the solvent is within this range, a process for forming the active material layer may be efficiently performed.

The positive current collector may be any one of various suitable current collectors that have a thickness ranging from about 3 to about 500 μm, do not cause any chemical change in the fabricated battery, and have high conductivity. For example, stainless steel, aluminum, nickel, titanium, heat-treated carbon, and aluminum or stainless steel that is surface-treated with carbon, nickel, titanium, silver, or the like may be used. The current collector may be processed to have fine irregularities on the surface thereof so as to enhance adhesive strength of the positive active material. The positive electrode current collector may have any of various forms including films, sheets, foils, nets, porous structures, foams, and non-woven fabrics.

Separately, a composition for forming a negative active material layer may be prepared by mixing a negative active material, a binder, a conductive agent, and a solvent.

Any negative active material in which lithium ions are intercalatable and deintercalatable may be used. Examples of the negative active material include graphite, a carbonaceous material such as carbon, lithium, and an alloy thereof, and a silicon oxide-based material. According to an implementation, silicon oxide may be used.

The binder may be used in an amount of about 1 to about 50 parts by weight based on 100 parts by weight of the negative active material. Examples of the binder may be the same as those of the positive electrode.

The amount of the conductive agent may be in a range of about 1 to about 5 parts by weight based on 100 parts by weight of the negative active material. If the amount of the conductive agent is within the range described above, the electrode may have excellent conductivity.

The amount of the solvent may be in a range of about 1 to about 10 parts by weight based on 100 parts by weight of the negative active material. If the amount of the solvent is within the range described above, the negative active material layer may be efficiently formed.

The same conductive agent and solvent as used for the positive electrode may be used for the negative electrode.

A negative current collector may be fabricated to have a thickness of about 3 to about 500 μm. The negative current collector may be any one of various current collectors that do not cause any chemical change in the fabricated battery and have conductivity. Examples of the current collector include copper, stainless steel, aluminum, nickel, titanium, heat-treated carbon, copper or stainless steel that is surface-treated with carbon, nickel, titanium, or silver, and aluminum-cadmium alloys. In addition, the negative current collector, in the same manner as the positive current collector, may be processed to have fine irregularities on the surface thereof so as to enhance an adhesive strength of the negative active material, and may be used in any of various forms including films, sheets, foils, nets, porous structures, foams, and non-woven fabrics.

A separator is interposed between the positive electrode and the negative electrode prepared as described above.

The separator may have a pore diameter of about 0.01 to about 10 μm and a thickness of about 5 to about 300 μm. Examples of the separator include olefin polymers such as polyethylene and polypropylene; and sheets or non-woven fabrics formed of glass fibers. When a solid electrolyte such as a polymer is employed as the electrolyte, the solid electrolyte may also serve as both the separator and electrolyte.

A lithium salt-containing non-aqueous electrolyte may include a non-aqueous electrolyte solution and lithium. As the non-aqueous electrolyte, a non-aqueous electrolyte solution, an organic solid electrolyte, or an inorganic solid electrolyte may be used.

Examples of the non-aqueous electrolytic solution include non-protic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, 2-methyl tetrahydrofuran, dimethylsulfoxide, 1,3-dioxolane, N,N-formamide, N,N-dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, or ethyl propionate.

Examples of the organic solid electrolyte include polyethylene derivatives, polyethylene oxide derivatives, polypropylene oxide derivatives, phosphoric acid ester polymers, polyvinyl alcohols, or polyvinylidene fluoride.

Examples of the inorganic solid electrolyte include nitride, halide, and sulfates of lithium such as Li₃N, LiI, Li₅NI₂, Li₃N—LiI—LiOH, Li₂SiS₃, Li₄SiO₄, Li₄SiO₄—LiI—LiOH, or Li₃PO₄—Li₂S—SiS₂.

The lithium salt is a material that is readily soluble in the non-aqueous electrolyte. The lithium salt may include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium, lithium tetraphenyl borate, and imide.

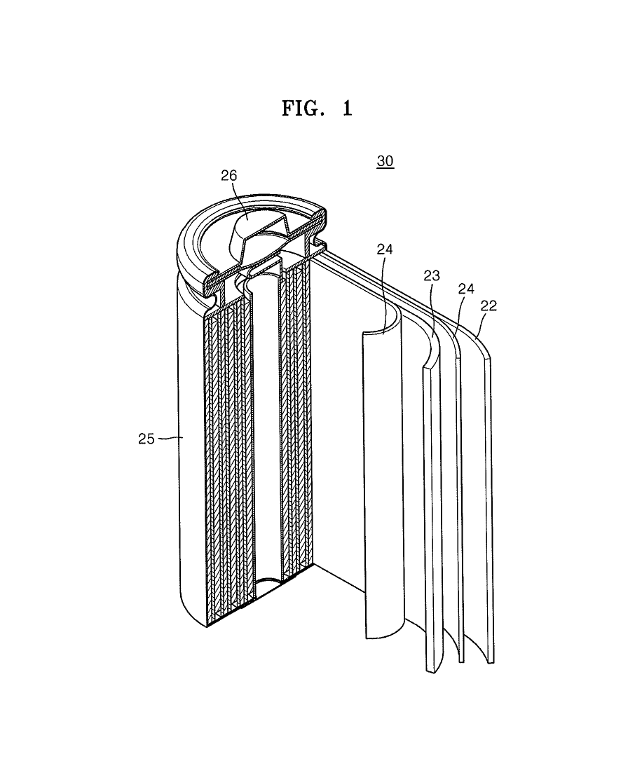

FIG. 1 is a perspective view showing a cross-section of a lithium secondary battery 30 according to an embodiment.

Referring to FIG. 1, the lithium secondary battery 30 may include a positive electrode 23, a negative electrode 22, separators 24 interposed between the positive electrode 23 and the negative electrode 22, and an electrolyte (not shown) impregnated into the positive electrode 23, the negative electrode 22, and the separators 24, a battery case 25, and a sealing member 26 sealing the case 25. The lithium secondary battery 30 may be prepared by sequentially stacking the negative electrode 22, the separator 24, and the positive electrode 23, and the separator 24, winding the stack, and inserting the wound stack into the battery case 25. The battery case 25 may be sealed by the sealing member 26, thereby completing the manufacture of the lithium secondary battery 30.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further it is to be understood that the embodiments are not limited to the particular details described in the Examples and Comparative Examples.

### Example 1

### Preparation of Positive Active Material

Nickel sulfate, cobalt sulfate, and manganese sulfate were dissolved in pure water to prepare a metal sulfate solution including nickel, cobalt, and manganese. In this regard, the amounts of the nickel sulfate, cobalt sulfate, and manganese sulfate were stoichiometrically controlled to obtain Ni_{0.923}Co_{0.051}Mn_{0.026}(OH)₂.

The metal sulfate solution was subjected to precipitation by controlling the pH of the metal sulfate solution to about 12.2 using a sodium hydroxide solution and an ammonia water in a nitrogen atmosphere, at 40 to 50° C., and precipitates were washed, water separated, and dried to obtain Ni_{0.923}Co_{0.051}Mn_{0.026}(OH)₂.

0.0125 mol % of TiO₂ having a particle diameter of about 100 nm and a rutile phase, and lithium hydroxide (LiOH) were added to Ni_{0.923}Co_{0.051}Mn_{0.026}(OH)₂, and mixed. In this regard, the amount of the lithium hydroxide was stoichiometrically controlled to obtain Li_{1.03}Ni_{0.916}Co_{0.051}Mn_{0.025}Ti_{0.0125}O₂. The mixture was heat-treated in a furnace at 750° C. under atmospheric condition for 15 hours to prepare a positive active material of Li_{1.03}Ni_{0.916}CO_{0.051}Mn_{0.025}Ti_{0.0125}O₂.

### Example 2

### Preparation of Positive Active Material

A positive active material Li_{1.03}Ni_{0.90}CO_{0.05}Mn_{0.025}Ti_{0.025}O₂ was prepared in the same manner as in Example 1, except that the amount of TiO₂ was 0.025 mol % instead of 0.0125 mol %.

### Comparative Example 1

### Preparation of Positive Active Material

Li_{1.03}Ni_{0.923}Co_{0.051}Mn_{0.026}O₂ was prepared in the same manner as in Example 1, except that 0.0125 mol % of TiO₂ was not used.

### Comparative Example 2

### Preparation of Positive Active Material

Li_{1.03}Ni_{0.90}Co_{0.05}Mn_{0.025}Al_{0.025}O₂ was prepared in the same manner as in Example 1, except that 0.025 mol % of Al₂O₃ was used instead of 0.0125 mol % of TiO₂.

### Comparative Example 3

### Preparation of Positive Active Material

Li_{1.03}Ni_{0.90}Co_{0.05}Mn_{0.025}Mg_{0.025}O₂ was prepared in the same manner as in Example 1, except that 0.025 mol % of Mg(OH)₂ was used instead of 0.0125 mol % of TiO₂.

### Comparative Example 4

### Preparation of Positive Active Material

Li_{1.03}Ni_{0.923}Co_{0.051}Mn_{0.026}O₂ was prepared in the same manner as in Comparative Example 1, except that the heat-treatment temperature was 850° C.

### Comparative Example 5

### Preparation of Positive Active Material

Li_{1.03}Ni_{0.916}Co_{0.051}Mn_{0.025}Ti_{0.0125}O₂ was prepared in the same manner as in Example 1, except that the heat-treatment temperature was 800° C.

### Preparation Example 1

### Preparation of Coin Half Cell

A 2032 coin half cell was prepared as follows using the positive active material prepared in Example 1.

96 g of the positive active material prepared in Example 1, 2 g of polyvinylidene fluoride, 47 g of N-methylpyrrolidone, as a solvent, and 2 g of carbon black, as a conductive agent, were mixed. Bubbles were removed from the mixture using a mixer to obtain a slurry for forming a positive active material layer that is uniformly dispersed.

The slurry for forming a positive active material layer was coated onto an aluminum-foil using a doctor blade to form a thin plate. The thin plate was dried at 135° C. for 3 hours or more, pressed, and dried in a vacuum to prepare a positive electrode.

The positive electrode and a lithium metal counter electrode were used to prepare a 2032 type coin half cell. A separator formed of a porous polyethylene (PE) film and having a thickness of about 16 μm was interposed between the positive electrode and the lithium metal counter electrode, and an electrolyte was injected thereto to prepare a 2032 type coin half cell.

Here, the electrolyte was a solution of 1.1 M LiPF₆ dissolved in a mixed solvent of ethylene carbonate (EC) and ethylmethyl carbonate (EMC) in a volume ratio of 3:5.

### Preparation Example 2

### Preparation of Coin Half Cell

A coin half cell was prepared in the same manner as in Preparation Example 1, except that the positive active material prepared in Example 2 was used instead of the positive active material prepared in Example 1.

### Comparative Preparation Example 1

### Preparation of Coin Half Cell

A coin half cell was prepared in the same manner as in Comparative Preparation Example 1, except that the positive active material prepared in Comparative Example 1 was used instead of the positive active material prepared in Example 1.

### Comparative Preparation Example 2

### Preparation of Coin Half Cell

A coin half cell was prepared in the same manner as in Comparative Preparation Example 1, except that the positive active material prepared in Comparative Example 2 was used instead of the positive active material prepared in Example 1.

### Comparative Preparation Example 3

### Preparation of Coin Half Cell

A coin half cell was prepared in the same manner as in Comparative Preparation Example 1, except that the positive active material prepared in Comparative Example 3 was used instead of the positive active material prepared in Example 1.

### Comparative Preparation Example 4

### Preparation of Coin Half Cell

A coin half cell was prepared in the same manner as in Comparative Preparation Example 1, except that the positive active material prepared in Comparative Example 4 was used instead of the positive active material prepared in Example 1.

### Comparative Preparation Example 5

### Preparation of Coin Half Cell

A coin half cell was prepared in the same manner as in Comparative Preparation Example 1, except that the positive active material prepared in Comparative Example 5 was used instead of the positive active material prepared in Example 1.

### Evaluation Example 1

### Analysis Using Differential Scanning Calorimeter

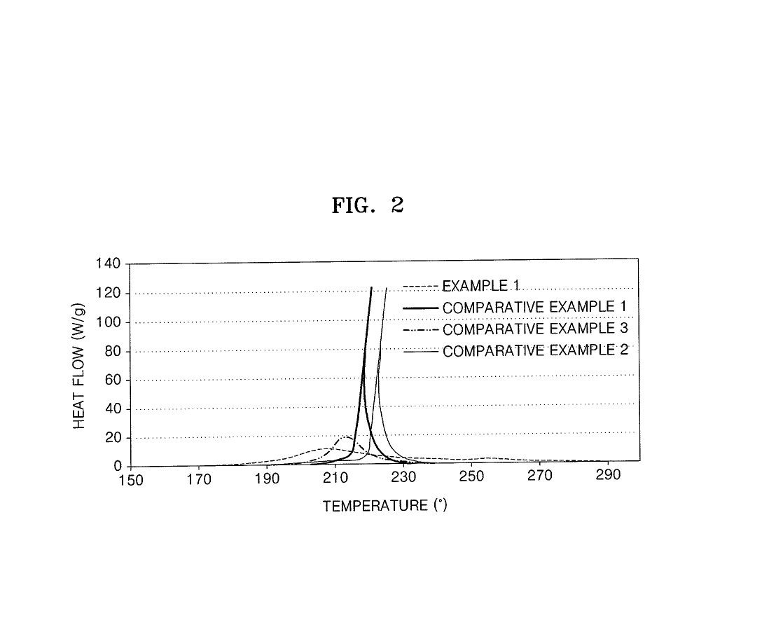

Thermal stabilities of the positive active materials prepared in Example 1 and Comparative Examples 1 to 3 were evaluated using a differential scanning calorimeter (DSC). The results are shown in FIG. 2.

Referring to FIG. 2, caloric value of the positive active material of Example 1 was lower than that of Comparative Examples 1 to 3, so that the positive active material of Example 1 exhibited better thermal stability than the positive active materials prepared in Comparative Examples 1 to 3. Thus, the lithium secondary battery prepared using the positive active material of Example 1 had better stability than lithium secondary batteries using the positive active materials of Comparative Examples 1 to 3.

### Evaluation Example 2

### Analysis Using Scanning Electron Microscope

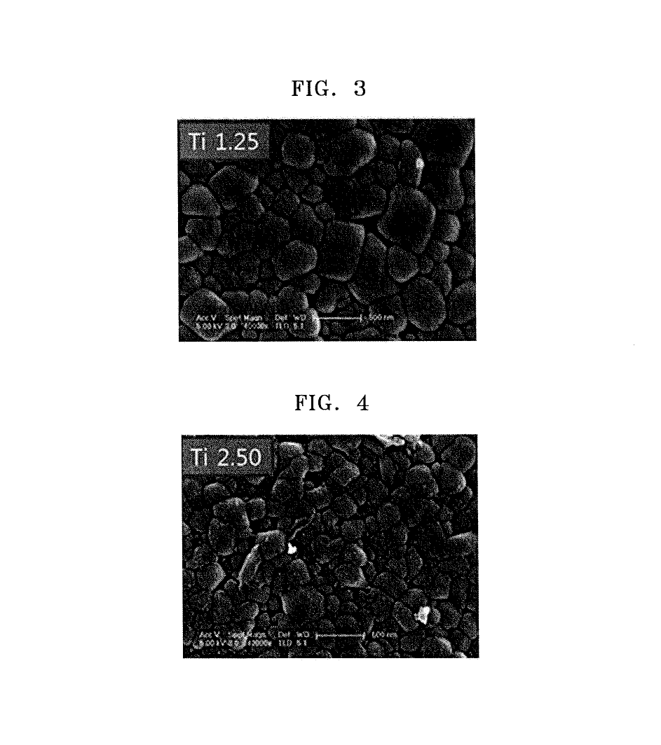

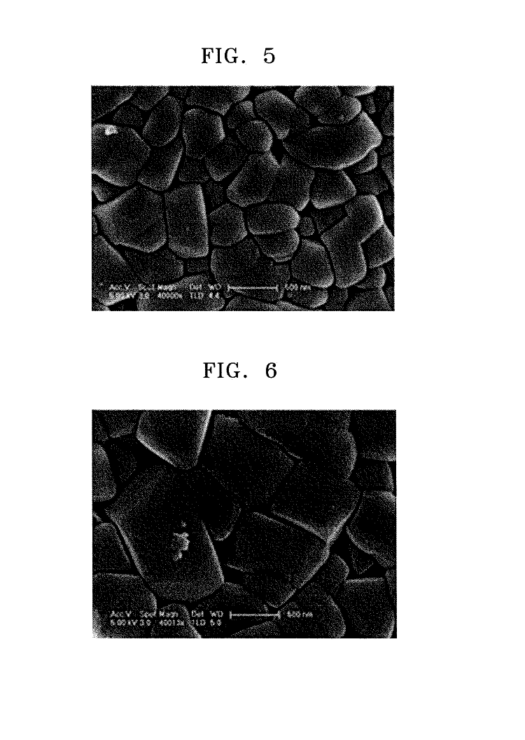

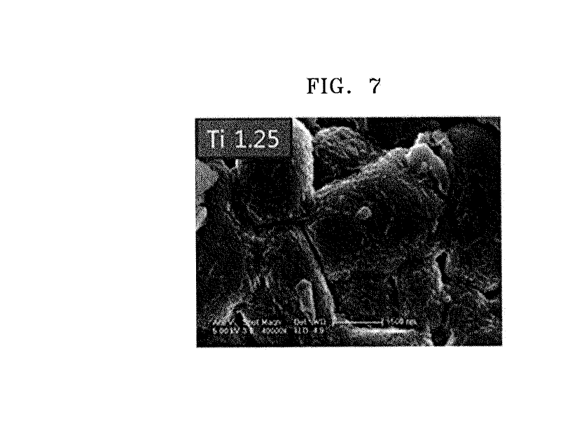

Positive active materials prepared in Examples 1 and 2 and Comparative Examples 1, 4, and 5 were analyzed using a scanning electron microscope. The results are shown in FIGS. 3 to 7, respectively. The particle size of primary particles of each of the positive active materials was measured using a scanning electron microscope, and the results are shown in Table 1 below.

Referring to FIGS. 3 and 4 and Table 1, it can be seen that as the amount of doped titanium increases in the positive active material, the size of primary particles of the positive active material decreases. In particular, the primary particles according to Examples 1 and 2 are smaller than the primary particles of Comparative Examples 1, 4, and 5.

TABLE 1

| | Diameter of primary particles (nm) |
|---|---|
| Example 1 | 200-400 |
| Example 2 | 100-300 |
| Comparative Example 1 | 300-600 |
| Comparative Example 4 | 400-900 |
| Comparative Example 5 | 400-700 |

### Evaluation Example 3

### Charge and Discharge Experiment 1

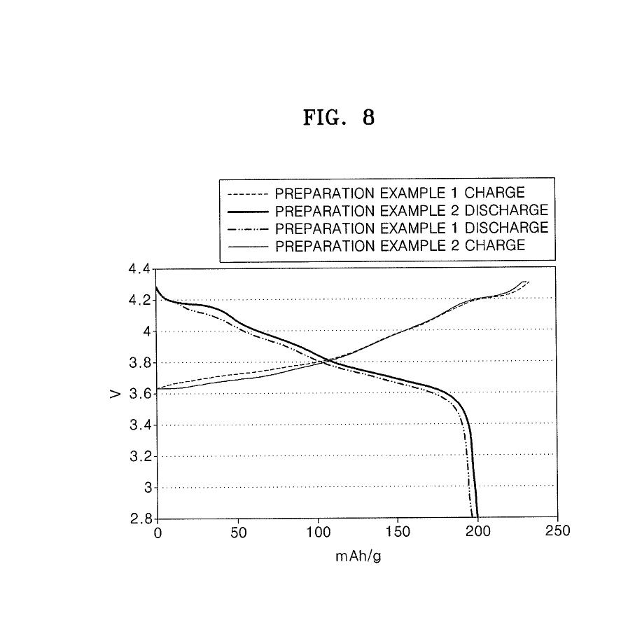

Charge and discharge characteristics of coin half cells prepared in Preparation Examples 1 and 2 were evaluated using a charge and discharge test system (Manufacturer: TOYO, Model No.: TOYO-3100), and the results are shown in FIG. 8.

Each of the coin half cells of Preparation Examples 1 and 2 was subjected to one cycle of charging and discharging at a rate of 0.1 C to perform a formation and one cycle of charging and discharging at a rate of 0.2 C to identify initial charge and discharge characteristics. Charging and discharging at a rate of 1 C were repeated 50 times to evaluate cycle characteristics. The charging was initiated in a constant current (CC) mode, continued in a constant voltage (CV) mode, and cut off at 4.3 V. The discharging was performed in a CC mode and cut off at 2.75 V.

Referring to FIG. 8, the coin half cells of Preparation Examples 1 and 2 had excellent charge and discharge characteristics.

### Evaluation Example 4

### Charge and Discharge Experiment 2

Charge and discharge characteristics of coin half cells prepared in Preparation Example 2 and Comparative Preparation Examples 1, 4, and 5 were evaluated using a charge and discharge test system (Manufacturer: TOYO, Model No.: TOYO-3100).

Each of the coin half cells of Preparation Example 2 and Comparative Preparation Examples 1, 4, and 5 was subjected to one cycle of charging and discharging at a rate of 0.1 C to perform a formation and one cycle of charging and discharging at a rate of 0.1 C to identify initial charge and discharge characteristics.

The charging was initiated in a CC mode, continued in a CV mode, and cut off at 4.3 V, and the discharging was performed in a CC mode and cut off at 1.5 V. The results are shown in Table 2 below.

Charge capacity and discharge capacity shown in Table 2 were charge and discharge capacities measured at a first cycle.

TABLE 2

| | Charge | Discharge |
|---|---|---|
| | capacity | capacity |
| | (mAh/g) | (mAh/g) |
| Preparation Example 2 | 231.08 | 197.22 |
| Comparative Preparation Example 1 | 239.96 | 220.61 |
| Comparative Preparation Example 4 | 238.39 | 210.76 |
| Comparative Preparation Example 5 | 224.13 | 195.1 |

### Evaluation Example 5

### Rate Capability

Rate capability of coin half cells prepared in Preparation Examples 1 and 2 and Comparative Preparation Example 1 was evaluated as follows.

First, the coin half cells were subjected to one cycle of charging and discharging at a rate of 0.1 C to perform a formation, and then one cycle of charging and discharging at rates of 0.1 C and 1 C, respectively.

The charging was initiated in a CC mode, continued in a CV mode, and cut-off at 4.3 V, and the discharging was performed in a CC mode and cut off at 2.75 V.

Charging and discharging were performed as described above, and indicated as a percentile of discharge capacity at 1 C-rate based on the discharge capacity at 0.1 C-rate. The results are shown in Table 3 below.

TABLE 3

| | 0.1 C | 1 C | 1 C/0.1 C |
|---|---|---|---|
| | Discharge | Discharge | High rate |
| | capacity | capacity | capability |
| | (mAh/g) | (mAh/g) | (%) |
| Preparation Example 1 | 199.68 | 180.6 | 90.44 |
| Preparation Example 2 | 197.22 | 171.56 | 86.99 |
| Comparative | 220.61 | 187.0 | 84.81 |
| Preparation Example 1 | | | |

Referring to Table 3, it can be seen that rate capabilities of Preparation Examples 1 and 2 were improved compared to that of Comparative Preparation Example 1.

By way of summation and review, a lithium nickel composite oxide may be used as the positive active material in a lithium secondary battery. The content of nickel may be increased in a lithium nickel composite oxide, to thereby increase a capacity per unit weight of a positive active material, and a transition metal may be added to the lithium nickel composite oxide, in order to complement safety and cycle properties of batteries.

However, it is desirable to improve the safety and charge and discharge characteristics of a lithium nickel composite oxide. As described above, a lithium secondary battery having excellent safety and charge and discharge characteristics may be prepared by using the positive active material for a lithium secondary battery according to one or more of the above embodiments.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope as set forth in the following claims.

What is claimed is:

1. A positive active material for a lithium secondary battery, the positive active material being a compound represented by Formula 1 below and being in a form of primary particles having a particle diameter in a range of 80 to 400 nm:
LiₐNiₓCo_{y}Mn_{z}M_{1-x-y-z}O₂ Formula 1
wherein metal M is selected from the group of B, Cr, V, Ti, Fe, Zr, Zn, Si, Y, Nb, Ga, Sn, Mo, and W,
1.0≦a≦1.2,
0.9≦x≦0.95,
0.1≦y≦0.5,
0.0≦z≦0.7, and
0.0<1-x-y-z≦0.3.

2. The positive active material as claimed in claim 1, wherein M is Ti.

3. The positive active material as claimed in claim 1, wherein the positive active material is a compound represented by Formula 2 below:
LiₐNiₓCo_{y}Mn_{z}Ti_{1-x-y-z}O₂ Formula 2
wherein
1.0≦a≦1.2,
0.9≦x≦0.95,
0.0≦z≦0.7, and
0.0<1-x-y-z≦0.3.

4. The positive active material as claimed in claim 1, wherein x in Formula 1 is in a range of 0.9 to 0.93.

5. The positive active material as claimed in claim 1, wherein z in Formula 1 is in a range of 0.02 to 0.03.

6. The positive active material as claimed in claim 1, wherein 1−x−y−z in Formula 1 is in a range of 0.01 to 0.03.

7. The positive active material as claimed in claim 1, wherein the positive active material is Li_{1.03}Ni_{0.90}CO_{0.05}Mn_{0.025}Ti_{0.025}O₂, Li_{1.03}Ni_{0.9125}Co_{0.05}Mn_{0.025}Ti_{0.0125}O₂, Li_{1.03}Ni_{0.914}Co_{0.051}Mn_{0.025}Ti_{0.01}O₂, or Li_{1.03}Ni_{0.905}Co_{0.05}Mn_{0.025}Ti_{0.02}O₂.

8. The positive active material as claimed in claim 1, wherein the positive active material is formed by a method that includes:
mixing a Ni—Mn—Co composite hydroxide, a lithium precursor, and a metal oxide of the metal M, wherein M has the same meaning as in Formula 1, the metal oxide having a particle diameter in a range of 10 to 100 nm, to form a mixture, and
heat-treating the mixture at 750 to 800° C. to form the compound represented by Formula 1, the compound being in a form of primary particles having a particle diameter in a range of 80 to 400 nm.

9. The positive active material as claimed in claim 8, wherein the metal oxide is titanium oxide.

10. The positive active material as claimed in claim 8, wherein the metal oxide is titanium oxide in a rutile phase.

11. The positive active material as claimed in claim 8, wherein the heat-treatment is performed under atmospheric conditions or in an oxygen atmosphere.

12. The positive active material as claimed in claim 8, wherein an amount of the metal oxide is in a range of 0.01 to 0.03 mol based on 1 mol of the lithium precursor.

13. The positive active material as claimed in claim 1, wherein the positive active material is formed by a method that includes:
mixing a composite hydroxide represented by Formula 3 and a lithium precursor to form a mixture, and
heat-treating the mixture at 750 to 800° C. to form the compound represented by Formula 1, the compound being in a form of primary particles having a particle diameter in a range of 80 to 400 nm,
NiₓCo_{y}Mn_{z}M_{1-x-y-z}(OH)₂ Formula 3
wherein metal M in Formula 3 has the same meaning as in Formula 1,
0.9≦x≦0.95,
0.1≦y≦0.5,
0.0≦z≦0.7, and
0.0<1-x-y-z≦0.3.

14. The positive active material as claimed in claim 13, wherein the composite hydroxide represented by Formula 3 is prepared by:
mixing a Ni-precursor, a Mn-precursor, a Co-precursor, a metal (M) precursor, and a solvent, wherein metal M has the same meaning as in Formula 1 and Formula 3, to form a mixture; and
adjusting the pH of the mixture to form a precipitate and drying the precipitate.

15. The method as claimed in claim 14, wherein the pH of the mixture is in a range of 12 to 12.4.

16. The method as claimed in claim 14, wherein the composite hydroxide represented by Formula 3 is a Ni—Mn—Co—Ti composite hydroxide represented by Formula 4 below:
NiₓCo_{y}Mn_{z}Ti_{1-x-y-z}(OH)₂ Formula 4
wherein
0.9≦x≦0.95,
0.1≦y≦0.5,
0.0≦z≦0.7, and
0.0<1-x-y-z≦0.3.

17. A positive electrode for a lithium secondary battery, the positive electrode comprising a positive active material for a lithium secondary battery that is represented by Formula 1 below, the positive active material being in a form of primary particles having a particle diameter in a range of 80 to 400 nm:
LiₐNiₓCo_{y}Mn_{z}M_{1-x-y-z}O₂ Formula 1
wherein metal M is selected from the group consisting of B, Cr, V, Ti, Fe, Zr, Zn, Si, Y, Nb, Ga, Sn, Mo, and W,
1.0≦a≦1.2,
0.9≦x≦0.95,
0.1≦y≦0.5,
0.0≦z≦0.7, and
0.0<1-x-y-z≦0.3.

18. A lithium secondary battery, comprising:
a positive electrode;
a negative electrode; and
a separator interposed between the positive and negative electrodes, the positive electrode being the positive electrode for a lithium secondary battery as claimed in claim 17.
